(19) United States
(12) Patent Application Publication
(10) Pub. No.: US 2008/0195661 A1
(43) Pub. Date: Aug. 14, 2008

(54) Digital media recognition using metadata

(75) Inventors: Stephen Watson, Toronto (CA); Elliott Pearl, Toronto (CA)

Correspondence Address: KALEIDESCAPE, INC., 440 POTRERO AVE., SUNNYVALE, CA, 94085-4117, US

(73) Assignee: KALEIDESCAPE, INC., MOUNTAIN VIEW, CA (US)

(21) Appl. No.: 11/704,174

(22) Filed: Feb. 8, 2007

(51) Int. Cl. G06F 17/30

(52) U.S. Cl. 707/104.1; 707/E17.009

(57) ABSTRACT

Digital media recognition without substantial user interaction, using information from personal digital libraries, or about users. Digital media recognition ambiguities resolved using that information, including:
a preponderance of entries in the user's personal library, including specific songs, authors, or genres;
a similarity relationship between the user's personal library and the corpus of a collective library;
demographic or specific information about the user;
equality to a song already present;
earlier results in resolving ambiguities;
location of a mobile system in a designated region;
location in a designated place within a house;
existence of any parental controls;
whether the imported digital entertainment information is being imported in bulk as part of a collection;
whether, according to a selected similarity metric for digital entertainment information, the imported digital entertainment information would be “closer” to one or more elements of the user's personal library.

### BACKGROUND OF THE INVENTION

Users sometimes import entertainment information, including songs, movies, and the like, into a personal digital library, such as one operating with a home entertainment system or a personal entertainment device. After import, users prefer to refer to that entertainment information using natural references, such as by author or title, rather than by a serial number or other computer identification. Most common encoding formats used to encode that entertainment information and most common recording media used to maintain that encoded entertainment information do not include natural references, but there are public services, both commercial and free, which can provide those references in response to media data from the media used to maintain that encoded entertainment information. The process of association is sometimes called DMR (digital media recognition).

One problem in known systems is that it might be difficult to associate that media data with those natural descriptions of that entertainment information. The user's device has access to the media itself, while those public services associate only known media data with those natural references.

In some systems, attempts are made to match that information from that media with those natural references, in response to such information as a list of tracks and their timing information (sometimes called “table of contents” or “TOC” recognition), or in response to such information as acoustic characteristics of the digital entertainment information (sometimes called “acoustic fingerprinting” recognition). While these systems often achieve recognition of the natural references associated with the digital entertainment information, they are not always successful, sometimes requiring user interaction, such as the user entering the desired information or the user responding to a prompt to select one of a set of possibilities.

### SUMMARY OF THE INVENTION

The invention provides techniques, such as embodied in apparatus or methods, by which information about or from the user's personal digital library, or other demographic or specific information about the user, assist in digital media recognition, before substantial user interaction.

In a preferred embodiment, digital media recognition is performed responsive to publicly available metadata, in which (1) that publicly available metadata, possibly assisted by reference to the user's personal digital library, can be used to filter the set of all possible items of digital media to a smaller set, and in which (2) at least some ambiguity or uncertainty can be resolved by reference to the user's personal digital library, or other demographic or specific information about the user. Possibly, some steps of filtering might be performed more than once, or some steps of disambiguation might be performed more than once, or both. (They need not be performed alternately.)

For example, if the user imports a commercial CD which might be identified as having been performed by the Academy of St. Martin in the Fields, or by the Boston Pops, and the user's personal library includes many works by the latter orchestra, and few by the former, any ambiguity is resolved by the system in favor of the latter orchestra, as being perceived by the system as the more likely user preference.

In a preferred embodiment, publicly-available metadata is used for a first set of attempts, with more specific information, such as information about the user's personal digital library, or other demographic or specific information about the user, being used when the publicly-available metadata is deemed insufficient to make a clear association. However, in the context of the invention, there is no specific requirement for this particular order. As described herein, all possible information might be used, either in a particular order, randomly or pseudo-randomly, or in an order responsive to other factors (such as, for example, the nature of the encoded entertainment information itself).

In a preferred embodiment, information about the user's personal digital library, or other demographic or specific information about the user, is used in at least one of two ways:
filtering the set of possible natural references that might be associated with the encoded entertainment information, from the entire set of all possible cases, which might number in the millions of possibilities, to a much smaller set of possible cases, which might number in the hundreds or tens of possibilities;
ranking the limited set of associations found by filtering, and picking a set of best matches in response to those rankings;

The nature of the invention is flexible enough to include a sequence of repeated steps of filtering and ranking, not necessarily in ordered pairs. For example, in a preferred embodiment, there are four possibilities: (1) information about the user's personal digital library used for filtering, (2) other demographic or specific information about the user also used for filtering, (3) information about the user's personal digital library used for ranking, (4) other demographic or specific information about the user also used for ranking, with no specific required order of application, and with no specific required number of steps performed.

Useful information from the user's personal library might include specific songs that are included, preferred authors or genres that are included, or a similarity relationship between the user's personal library and the corpus of a collective library.

In a preferred embodiment, demographic or specific information about the user is obtained responsive to a generic description of the user's personal library (e.g., “mostly heavy metal rock”), along with conclusions it might be reasonable to make about the user responsive thereto. For example, if the user imports a commercial CD which might be identified as either “Sesame Street” or as a popular song by Kelly Clarkson, and the user's personal library includes songs which indicate that the user is likely to be a high-school student in a small Midwestern town, this ambiguity might be resolved by the system in favor of the latter genre, as being perceived by the system as the more likely user preference.

Similarly, the system might resolve ambiguity using one or more of the following possibilities:
Whether the table-of-contents (TOC) metadata matches the TOC values read from the media data. In a preferred embodiment, the system might consider the number or length (or both) of a set of audio tracks, even though the metadata may report a TOC including audio, inter-session gap, and data tracks, or bonus tracks.
In one example, a set of metadata from another source (in this example, AMG) contains two fields about box sets; a Boolean flag saying “this is a box set”, and a numeric field counting the number of discs in the album. These fields may contain inconsistent information.
In one example, a TOC is just a sequence of track start times, hence corresponding to a count of tracks. The metadata from another source (in this example, AMG) may also contain a numeric field for the number of tracks. These may be inconsistent as in the cases when there are bonus tracks or data tracks on the disc with an inter-session gap (treated as a track itself).
The nature and value of any natural references within the imported digital entertainment. These might include: what encoding or media format applies to the imported digital entertainment itself, to any features of the imported digital entertainment, to any features of any associated imported digital entertainment, or to any features of any associated metadata. The system might be responsive to a comparison of these factors with possible matches, to a threshold goodness-of-match, to a clustering technique, or to another form of comparison.
Whether the imported digital entertainment information would be unnecessarily identical to a song already in user's personal library, responsive to reasoning that the user would not knowingly purchase multiple copies.
Whether the ambiguity has been successfully resolved in earlier cases, which the system has recorded, responsive to reasoning that the same resolution would be made.
Whether the digital media recognition device is located in a region where one song is more likely to be preferred over another, responsive to reasoning that the designated region includes users whose preferences follow the common public in that region. In the context of the invention, a “region” might be as broad as a country or continent, or might be as narrow as a particular zip code or census tract. For example, in cases where the system is installed in a primarily French-speaking portion of Quebec, a French-language version might be preferred, responsive to reasoning about the likely nature of the user.
Whether the presentation device is located in a designated place within a house, responsive to reasoning that choices preferred for the common areas of the house (e.g., the dining room) might differ substantially from choices preferred for more private areas (e.g., a home office).
Whether the presentation device is subject to any parental controls, responsive to reasoning that choices preferred (at least by those exercising the parental controls!) do NOT include certain designated songs or other media.
Whether the imported entertainment information is being imported in bulk as part of a collection. In the context of the invention, the concept of considering a grouping for the entertainment information involves a wide variety of possibilities, the following being only a few examples thereof:
   In one example, a particular item of imported entertainment information might be resolved as being closest to a cluster of possible natural references imported in bulk as part of that collection.
   In one example, a set of multiple particular items of imported entertainment information, imported in bulk as part of a collection, might be resolved as being closest to each other.
   In one example, a set of multiple particular items of imported entertainment information, imported in bulk as part of a collection, might be resolved as being grouped into the smallest (or the least ambiguous) set of clusters.
   In one example, a global ranking for goodness-of-match for the entire collection might be determined, with ambiguities resolved in favor of an entire batch import having the best global ranking for goodness-of-match.
   In one example, a ranking for goodness-of-match for an entire collection might be determined with reference to a community of users of systems from the same dealer, the same manufacturer (e.g., Kaleidescape, Inc.), or other ad hoc user affinity groups or communities formed by those users themselves, with ambiguities resolved in favor of a the entire batch import having the best ranking for goodness-of-match to the union of personal libraries in one or more of those affinity groups or communities.
Whether, according to a selected similarity metric for entertainment information, the imported entertainment information would be “closer” to one or more elements of the user's personal library. This particular aspect could be extended to clustering the user's personal library according to that selected similarity metric, and treating each cluster as a separate personal library. For example, a user whose personal library clusters well into “Bluegrass” and “Country and Western” would probably be less interested in entertainment information including primarily whale songs.
Whether the imported entertainment information is being imported as part of a “boxed set”. Many users' personal libraries include large amounts of entertainment information already distributed by sellers in boxed sets. In the context of the invention, the concept of boxed sets includes a wide variety of possibilities, the following being only a few examples thereof:
   In one example, a particular item of imported entertainment information might be resolved as being closest to an element of a boxed set (such as for example, a seller-defined collection), where the user's personal library already includes other elements in that boxed set.
   In one example, a particular item of imported entertainment information might be resolved as completing a boxed set, where the user's personal library already includes other elements in that boxed set.
   In one example, a particular item of imported entertainment information might be resolved as included in a boxed set related to other boxed sets already part of the user's personal library. In one example, if the user's personal library might include the first and third seasons of “The Sopranos”, associating an item of imported entertainment information with a natural reference that is part of the second season of that television show might be considered likely.
   In one example, a particular item of imported entertainment information might be resolved as included in a boxed set if that item includes “bonus tracks” found in boxed sets, at least some of which are already part of the user's personal library.
Whether the imported entertainment information includes both audio and data tracks. One property of libraries is that some particular media carriers of entertainment information include data tracks, while others do not.
Whether navigational information included with the imported entertainment information matches another known set of imported entertainment information. In one example, on each CD it is relatively easy to separate and identify data that forms the navigational layer from actual audio data encoded on that CD. In this example, the system would apply a hash function to that data, from all identified CDs, recording and associating the hashed values with those identified CDs. In this example, the system would compare a hash value for an ambiguous or unknown CD with those recorded hash values from its known library of CDs (not necessarily limited to the user's library), seeking a match. This has the effect that a hash function value of non-audio data might be an example of recordable and comparable metadata.

After reading this application, those skilled in the art would recognize that these particular matching techniques are individual cases of a wide variety of possibilities, including combinations, conjunctions, intersections or unions of these cases, and the like. Those skilled in the art would recognize that it would be possible to “mix and match” these cases, or to add other cases using data available to an embodiment, to produce a much larger number of possibilities than explicitly mentioned herein. These alternatives would not require new invention or undue experimentation. They are part of the scope and spirit of the invention.

### BRIEF DESCRIPTION OF THE DRAWINGS

FIG. 1 shows a block diagram of a system capable of performing digital media recognition using metadata.

FIG. 2 shows a process flow diagram of a method of performing digital media recognition using metadata.

### DETAILED DESCRIPTION

### Definitions

The term “user”, and the like, refers generally to individuals and groups of persons, and other entities, making use of an embodiment.
The phrase “entertainment information”, and the like, refers generally to encoded information for entertainment of users, such as songs, other audio or video signals, and more generally, any information of use to users. Although embodiments are described with reference to entertainment, in the context of the invention, there is no particular requirement that the encoded information is for entertainment purposes, or even that the encoded information includes a representation of data perceivable by a human being. In one example, that information might include data for inclusion in a database, for systems control, or for a wide variety of other purposes.
The phrase “personal digital library”, and the like, refers generally to any collection of entertainment information, as broadly described herein, whether that collection is maintained on a single device, a collection of devices, or a storage element capable of being transferred among devices. In one example, a personal digital library might include a set of songs recorded on a hand-held device, such as a cellular telephone or an iPod.
The phrase “natural reference”, and the like, refers generally to any metadata descriptive of entertainment information, as broadly described herein. In several examples, a natural reference might include a title, author, performer, producer, genre, encoding format, and the like.
The phrase “encoding format”, and the like, refers generally to any technique or method by which entertainment information, as broadly described herein, is maintained for reading or writing on a physical medium.
The phrase “media data”, and the like, refers generally to any metadata possible to find on the physical medium that includes an encoding of the entertainment information, as broadly described herein.
The phrase “collective library”, and the like, refers generally to a library maintained by a manufacturer of an embodiment, for the benefit of end user customers of that manufacturer.

### System Elements

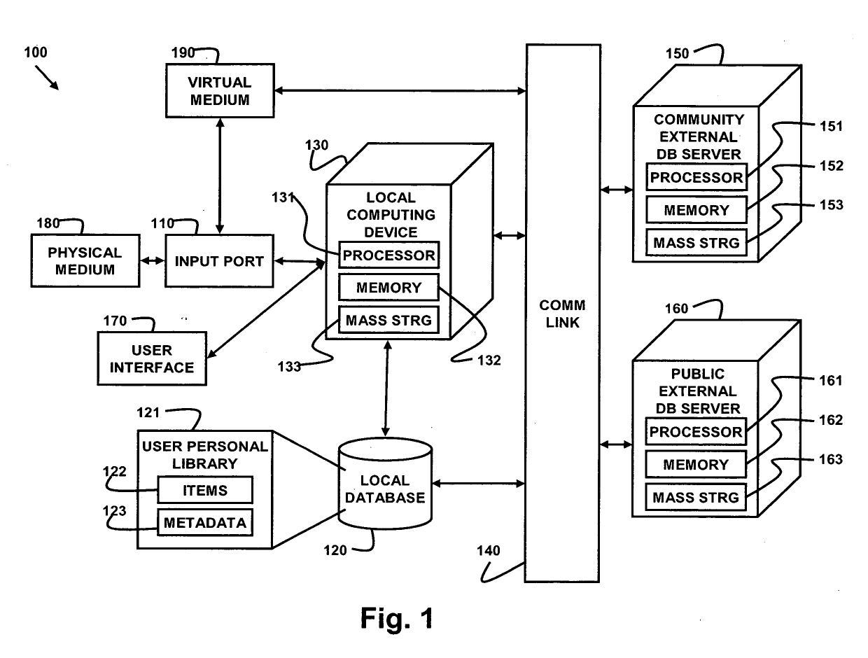

FIG. 1 shows a block diagram of a system capable of performing digital media recognition using metadata.

A system 100 includes elements as shown in FIG. 1, including at least the following:
110 an input port
120 a local database
130 a local computing device
140 a communication link
150 a community external database server
160 a public external database server
170 a user interface

Operation of the system 100 includes either a physical medium 180 maintaining encoded entertainment information for storage, or a virtual medium 190 maintaining encoded entertainment information either on another storage device or in communication transit, such as possibly using the communication link 140 or another communication link (not shown).

The input port 110 is disposed for being coupled to encoded entertainment information, either in the form of a physical medium 180 or in the form of a virtual medium 190, and is further disposed for being coupled to the local computing device 130.

As further described herein, the local computing device 130 is therefore capable of receiving encoded entertainment information, either from a physical medium 180 (such as a CD, DVD, or other device), or from a virtual medium 190 (such as a disk image, a sequence of one or more messages) and determining, responsive to information maintained in the system 100, metadata including natural references to encoded entertainment information.

The local database 120 includes a user personal library 121, which itself includes a set of entertainment information items 122 along with their associated metadata 123. In a preferred embodiment, the user personal library 121 is coupled to the computing device 130 and disposed for being controlled and maintained for storage thereby.

The local computing device 130 includes a local processor 131, local program and data memory 132, and local mass storage 133. The local processor 131 is coupled to the local program and data memory 132, and operates under control of instructions maintained therein. The local processor 131 might also write one or more intermediate data values to the local data memory 132, which maintains those values for use as directed by the local processor 131.

The communication link 140 is disposed for being coupled to at least one or more of: the local database 120, the local computing device 130, the community external database server 150, the public external database server 160, the virtual medium 190. The communication link 140 is capable of transporting information between or among these elements. In a preferred embodiment, the communication link 140 includes a wired or wireless LAN, VLAN, VPN, WAN, an enterprise network, internet, private or public switched network, any combination or conjunction thereof, or any other system capable of performing the functions described herein.

The community external database server 150 is disposed for being coupled to the communication link 140 or another communication link (not shown). The community external database server 150 includes a community server processor 151, community server processor program and data memory 152, and community server mass storage 153. The community server processor 151 is coupled to the community server program and data memory 152, and operates under control of instructions maintained therein. The community server processor 151 might also write one or more intermediate data values to the community server data memory 152, which maintains those values for use as directed by the community server processor 151.

In a preferred embodiment, the community external database server 150 operates as the server in a client-server interactive process, receiving requests from one or more computing devices 130 using the communication link 140, and generating responses thereto. As described herein, the community external database server 150 maintains a community library for use by one or more computing devices 130 included in systems made by a manufacturer of one or more embodiments.

The public external database server 160 is disposed for being coupled to the communication link 140 or another communication link (not shown). The public external database server 160 includes a public server processor 161, public server processor program and data memory 162, and public server mass storage 163. The public server processor 161 is coupled to the public server program and data memory 162, and operates under control of instructions maintained therein. The public server processor 161 might also write one or more intermediate data values to the public server data memory 162, which maintains those values for use as directed by the public server processor 161.

In a preferred embodiment, the public external database server 160 operates as the server in a client-server interactive process, receiving requests from one or more computing devices 130 using the communication link 140, and generating responses thereto. As described herein, the public external database server 160 maintains a public library for use by one or more computing devices 130, whether or not included in systems made by a manufacturer of one or more embodiments.

The user interface 170 is disposed for presenting information to one or more users (not shown), and for receiving commands or other information therefrom.

Operation of the system 100 includes either a physical medium 180 (not part of the system 100) maintaining encoded entertainment information for storage, or a virtual medium 190 (not part of the system 100) maintaining encoded entertainment information either on another storage device or in communication transit, such as possibly using the communication link 140 or another communication link (not shown).

### Methods of Operation

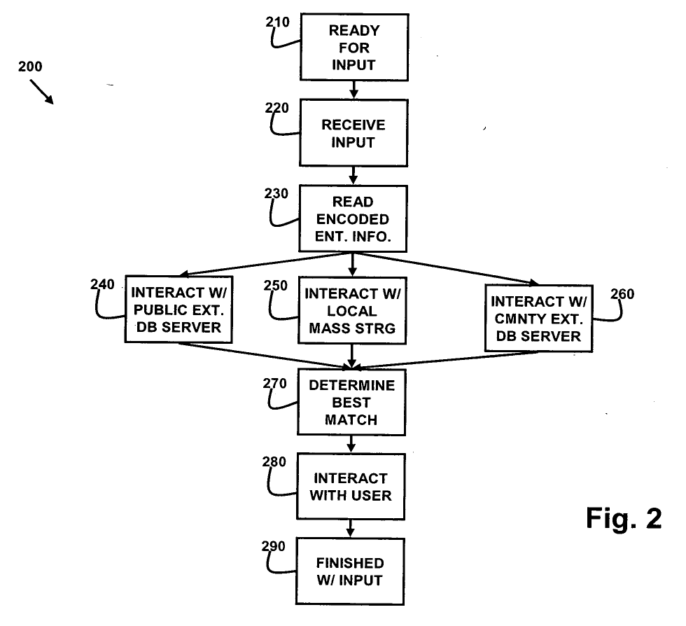

FIG. 2 shows a process flow diagram of a method of performing digital media recognition using metadata.

A method 200 includes flow points and method steps as shown in FIG. 2, including at least the following:
210 ready for input of physical media 180 or virtual media 190
220 receiving input of physical media 180 or virtual media 190
230 read encoded entertainment information
240 interact with public external database server 160
250 interact with community external database server 150
260 interact with local mass storage 133
270 determining a best match of natural reference for encoded entertainment information
280 interact with user
290 finished with input of physical media 180 or virtual media 190

At a flow point 210, the system 100 is ready for input of encoded entertainment information using either physical media 180 or virtual media 190. In a preferred embodiment, the system 100 waits at the flow point 210 until input of one or more items of encoded entertainment information begins.

At a flow point 220, the system 100 has begun receiving input of one or more items of encoded entertainment information using either physical media 180 or virtual media 190. In a preferred embodiment, the system 100 receives the one or more items of encoded entertainment information, under control of the local computing device 130.

At a step 230, the system 100, under control of the local computing device 130, reads the one or more items of encoded entertainment information.

At a step 240, the system 100, under control of the local computing device 130, requests metadata, including natural references, regarding the one or more items of encoded entertainment information, from the public external database server 160. If the system 100 is able to obtain those natural references, the method 200 proceeds to the flow point 210, where the system 100 is ready to receive further items of encoded entertainment information.

At a step 250, the system 100, under control of the local computing device 130, requests metadata, including natural references, regarding the one or more items of encoded entertainment information, from the community external database server 150. If the system 100 is able to obtain those natural references, the method 200 proceeds to the flow point 210, where the system 100 is ready to receive further items of encoded entertainment information.

At a step 260, the system 100, under control of the local computing device 130, obtains information regarding the user's private library from local mass storage 133.

At a step 270, as described above, the system 100, under control of the local computing device 130, performs a number of heuristics to attempt to determine a best match of metadata, including natural references, regarding the one or more items of encoded entertainment information. If the system 100 is able to find a satisfactory match, the method 200 proceeds to the flow point 210, where the system 100 is ready to receive further items of encoded entertainment information.

At a step 280, as described above, the system 100, under control of the local computing device 130, interacts with one or more users, using the user interface 170, to narrow down (possibly to a single item) the metadata, including natural references, to associate with the one or more items of encoded entertainment information.

At a flow point 290, the system 100 has completed its treatment of encoded entertainment information using either physical media 180 or virtual media 190. The method proceeds to the flow point 210.

1. A method, including steps of
performing a digital media recognition technique in response to one or more of
information about a particular user's personal digital library;
information about a second library gleaned from digital media recognition techniques performed for a defined community of users;
information about the particular user;
without substantial user interaction.

2. A method as in claim 1, wherein information about the particular user's personal digital library includes
a statistical measure of metadata relating to songs included in a second library.

3. A method as in claim 2, wherein that metadata includes one or more of an artist, date, genre for that digital entertainment information.

4. A method as in claim 1, wherein information about the particular user's personal digital library includes
a statistical measure of metadata relating to songs included in that library.

5. A method as in claim 4, wherein that metadata includes one or more of an artist, date, genre for that digital entertainment information.

6. A method as in claim 1, wherein that defined community is responsive to
a manufacturer of a system with which the method is performed.

7. A method as in claim 6, wherein that second library is generally available substantially only to that defined community.

8. A method as in claim 1, wherein that second library includes metadata uploaded from a system with which the method is performed for that particular user, without substantial user interaction.

9. A method as in claim 8, wherein that second library is generally available substantially only to that defined community.

10. A method, including steps of
performing digital media recognition in response to one or more similarity metrics between a set of imported entertainment information and one or more of
a set of content in a particular user's personal digital library;
a set of metadata relating to content in a particular user's personal digital library;
a set of content in a second library gleaned from digital media recognition techniques performed for a defined community of users;
a set of metadata relating to content in a second library gleaned from digital media recognition techniques performed for a defined community of users.

11. A method as in claim 10, including steps of
separating into a defined set of clusters, in response to at least one of those similarity metrics, one or more of
that particular user's personal digital library;
one or more second libraries gleaned from digital media recognition techniques performed for a defined community of users.

12. A method as in claim 11, wherein
those steps of performing digital media recognition are responsive to one or more such defined set of clusters,
with the effect of treating those one or more such defined set of clusters as a separate personal library.

13. A method as in claim 10, wherein
at least one of those similarity metrics is responsive to a measure of difference between elements of entertainment information.

14. A method as in claim 10, wherein
at least one of those similarity metrics is responsive to a set of defined clusters in one or more of
that particular user's personal digital library;
one or more second libraries gleaned from digital media recognition techniques performed for a defined community of users.

15. A physical medium maintaining instructions interpretable by a computing device to
perform digital media recognition in response to one or more of
information about a particular user's personal digital library;
information about a second library gleaned from digital media recognition techniques performed for a defined community of users;
information about the particular user;
without substantial user interaction.

16. A physical medium as in claim 15, wherein information about the particular user's personal digital library includes
a statistical measure of metadata relating to songs included in a second library.

17. A physical medium as in claim 16, wherein that metadata includes one or more of an artist, date, genre for that digital entertainment information.

18. A physical medium as in claim 15, wherein information about the particular user's personal digital library includes
a statistical measure of metadata relating to songs included in that library.

19. A physical medium as in claim 18, wherein that metadata includes one or more of an artist, date, genre for that digital entertainment information.

20. A physical medium as in claim 15, wherein that second library includes metadata uploaded from a system with which the method is performed for that particular user, without substantial user interaction.

21. A physical medium as in claim 20, wherein that second library is generally available substantially only to that defined community.

22. A physical medium as in claim 15, wherein that defined community is responsive to
a manufacturer of a system with which the method is performed.

23. A physical medium as in claim 22, wherein that second library is generally available substantially only to that defined community.

24. A physical medium maintaining instructions interpretable by a computing device to
perform digital media recognition in response to one or more similarity metrics between a set of imported entertainment information and one or more of
a set of content in a particular user's personal digital library;
a set of metadata relating to content in a particular user's personal digital library;
a set of content in a second library gleaned from digital media recognition techniques performed for a defined community of users;
a set of metadata relating to content in a second library gleaned from digital media recognition techniques performed for a defined community of users.

25. A physical medium as in claim 24, including instructions interpretable to
separate into a defined set of clusters, in response to at least one of those similarity metrics, one or more of
that particular user's personal digital library;
one or more second libraries gleaned from digital media recognition techniques performed for a defined community of users.

26. A physical medium as in claim 25, wherein
those instructions to perform digital media recognition are responsive to one or more such defined set of clusters,
with the effect of treating those one or more such defined set of clusters as a separate personal library.

27. A physical medium as in claim 24, wherein
at least one of those similarity metrics is responsive to a measure of difference between elements of entertainment information.

28. A physical medium as in claim 24, wherein
at least one of those similarity metrics is responsive to a set of defined clusters in one or more of
that particular user's personal digital library;
one or more second libraries gleaned from digital media recognition techniques performed for a defined community of users.

29. Apparatus, including
means for receiving digital media information;
means for performing recognition of that digital media information in response to one or more of
information about a particular user's personal digital library;
information about a second library gleaned from digital media recognition techniques performed for a defined community of users;
information about the particular user;
without substantial user interaction.

30. Apparatus as in claim 29, wherein information about the particular user's personal digital library includes
a statistical measure of metadata relating to songs included in a second library.

31. Apparatus as in claim 30, wherein that metadata includes one or more of an artist, date, genre for that digital entertainment information.

32. Apparatus as in claim 29, wherein information about the particular user's personal digital library includes
a statistical measure of metadata relating to songs included in that library.

33. Apparatus as in claim 32, wherein that metadata includes one or more of an artist, date, genre for that digital entertainment information.

34. Apparatus as in claim 29, wherein that defined community is responsive to
a manufacturer of a system with which the method is performed.

35. Apparatus as in claim 34, wherein that second library is generally available substantially only to that defined community.

36. Apparatus as in claim 29, wherein that second library includes metadata uploaded from a system with which the method is performed for that particular user, without substantial user interaction.

37. Apparatus as in claim 36, wherein that second library is generally available substantially only to that defined community.

38. Apparatus, including
means for receiving digital media information;
means for performing recognition of that digital media information in response to one or more similarity metrics between a set of imported entertainment information and one or more of
a set of content in a particular user's personal digital library;
a set of metadata relating to content in a particular user's personal digital library;
a set of content in a second library gleaned from digital media recognition techniques performed for a defined community of users;
a set of metadata relating to content in a second library gleaned from digital media recognition techniques performed for a defined community of users.

39. Apparatus as in claim 38, including
means for separating into a defined set of clusters, in response to at least one of those similarity metrics, one or more of
that particular user's personal digital library;
one or more second libraries gleaned from digital media recognition techniques performed for a defined community of users.

40. Apparatus as in claim 39, wherein
those means for performing recognition are responsive to one or more such defined set of clusters,
with the effect of treating those one or more such defined set of clusters as a separate personal library.

41. Apparatus as in claim 38, wherein
at least one of those similarity metrics is responsive to a measure of difference between elements of entertainment information.

42. Apparatus as in claim 38, wherein
at least one of those similarity metrics is responsive to a set of defined clusters in one or more of
that particular user's personal digital library;
one or more second libraries gleaned from digital media recognition techniques performed for a defined community of users.
